(19) United States
(12) Patent Application Publication
(10) Pub. No.: US 2006/0192731 A1
(43) Pub. Date: Aug. 31, 2006

(54) Plasma display device

(76) Inventors: Tomoya Matsui, Kawasaki (JP); Makoto Onozawa, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/362,142

(22) Filed: Feb. 27, 2006

(30) Foreign Application Priority Data
Feb. 28, 2005 (JP) 2005-053730

(51) Int. Cl. G09G 3/28

(52) U.S. Cl. 345/60

(57) ABSTRACT

A plasma display device includes: a plasma display panel; driving circuits for applying voltages to multiple electrodes of the panel; and a power supply circuit for supplying power supply voltage to the driving circuits, wherein the driving circuits apply positive sustain discharge voltage higher than ground and negative sustain discharge voltage lower than ground to the multiple electrodes at the sustain discharge, the driving circuit has high-level shift circuits and low-level shift circuits and includes pre-driver ICs to which an activation potential of the high-level shift circuit, an activation potential of the low-level shift circuit, and a reference potential have to be applied, the power supply circuit includes a positive sustain discharge voltage generating unit and a reference potential generating unit which generates the reference potential from the positive sustain discharge voltage, and when activating the pre-driver IC, an activation potential is applied prior to the reference potential.

### CROSS-REFERENCE TO RELATED APPLICATION

The present application claims priority from Japanese Patent Application No. JP 2005-053730 filed on Feb. 28, 2005, the content of which is hereby incorporated by reference into this application.

### TECHNICAL FIELD OF THE INVENTION

The present invention relates to an A/C plasma display panel (PDP) used for a display device of a personal computer and a workstation, a flat TV, and a plasma display for displaying advertisements, information, and others.

### BACKGROUND OF THE INVENTION

In an AC color PDP device, an address/display separation (ADS) method in which a period when the cells to be displayed are determined (address period) and a display period when discharges for display lighting are performed (sustain period) are separated is widely employed. In this method, charge is accumulated in the cells, which are to be turned on, in the address period, and discharges for display are performed by utilizing the accumulated charge in the sustain period.

Also, plasma display panels include: a two-electrode type PDP in which a plurality of first electrodes extending in a first direction are provided in parallel to each other and a plurality of second electrodes extending in a second direction which is perpendicular to the first direction are provided in parallel to each other; and a three-electrode type PDP in which a plurality of first electrodes and second electrodes extending in a first direction are alternately provided in parallel to each other and a plurality of address electrodes extending in a second direction perpendicular to the first direction are provided in parallel to each other. In recent years, the three-electrode type PDPs have been widely used.

In a general structure of the three-electrode type PDPs, first (X) electrodes and second (Y) electrodes are alternately provided in parallel to each other on a first substrate, address electrodes extending in a direction which is perpendicular to the extending direction of the first and second electrodes are provided on a second substrate opposite to the first substrate, and the surfaces of the electrodes are covered by dielectric layers. On the second substrate, barrier ribs which are extending in one direction and arranged in stripes between the third electrodes in parallel to the third electrodes or barrier ribs which are arranged in lattice pattern and disposed in parallel to the address electrodes and the first and second electrodes so as to individually separate the cells are further provided, and the first and the second substrates are attached to each other after phosphor layers are formed between the barrier ribs. Therefore, the dielectric layers and the phosphor layers and further the barrier ribs are formed on the third electrodes.

Reset discharges are generated in all of the cells by applying voltage between the first and second electrodes to make the charge (wall charge) near the electrodes uniform. Then, the addressing for selectively leaving the wall charge in the cells to be turned on is performed by sequentially applying scan pulses to the second electrodes and applying address pulses to the address electrodes in synchronization with the scan pulses. Subsequently, sustain discharge pulses of voltages of alternately changed polarities are applied between the two adjacent first and second electrodes where discharges are to be performed. By doing so, the sustain discharges are generated in the cells to be turned on in which the wall charge has been formed through the addressing, thereby performing the lighting. The phosphor layers emit light by ultraviolet rays generated through the discharges, and the light is seen through the first substrate. Therefore, the first and second electrodes are comprised of non-transparent bus electrodes formed of metal materials and transparent electrodes such as ITO films, and the light generated in the phosphor layers can be seen through the transparent electrodes.

FIG. 1 is a diagram showing the entire structure of a standard plasma display device (PDP device). As shown in FIG. 1, in a plasma display panel 10, laterally extending X electrodes X1, X2, . . . , Xn and Y electrodes Y1, Y2, . . . , Yn are alternately disposed, and vertically extending address electrodes A1, A2, . . . , Am are disposed so as to intersect with the n sets of the X electrodes and the Y electrodes, and cells are formed at the intersecting parts. Therefore, n display rows and m display columns are formed.

As shown in FIG. 1, the PDP device has an address driving circuit 11 which drives the m lines of address electrodes, a X driving circuit 12 which applies voltages to the n lines of X electrodes in common, a Y driving circuit 13 which applies scan pulses and common voltages to the n lines of Y electrodes, a control circuit 14 which controls each of the parts, and a power supply circuit 15 which supplies power to each of the parts.

Next, operations of the PDP device will be described. In each cell of the PDP, only On/Off can be selected, and lighting luminance cannot be changed, i.e., grayscale display cannot be performed. Therefore, one frame is divided into a plurality of predetermined weighted sub-fields, and grayscale display is performed for each cell by combining the lighting sub-fields in one frame. The sub-fields normally have the same driving sequence except for the number of sustain discharges.

In the PDP, the discharge for displaying is performed by applying voltages between the X electrode and the Y electrode. In this case, a positive voltage with respect to the ground is applied to one electrode and a negative voltage with respect to the ground is applied to the other electrode so as to reduce an absolute value of the voltages to be generated and reduce the withstand voltage of the driver IC which constitutes a driving circuit.

FIG. 2 is a diagram showing driving waveforms of one sub-field in the PDP device, which shows the driving waveforms of the case where the positive and negative voltages are applied to the X electrode and the Y electrode as described above.

In the front half of the reset period, 0 V is applied to the address electrode A. In this state, a negative reset pulse 101 in which a potential is gradually lowered to reach a constant value is applied to the X electrode, and a positive reset pulse 103 in which a predetermined potential is applied and then the potential gradually increases to a voltage Vw is applied to the Y electrode. By doing so, in all the cells, the discharge for setting the X electrode as a cathode and setting the Y electrode as an anode is generated. Since obtuse waves in which the potentials are gradually changed are applied here, slight discharges and charge formation are repeated, and a positive wall charge is formed near the X electrode and a negative wall charge is formed near the Y electrode in all of the cells.

In the latter half of the reset period, a predetermined positive voltage 105 is applied to the X electrode and a charge adjusting pulse 107 in which a voltage is gradually reduced from positive to negative is applied to the Y electrode so that the wall charge amount formed near the X electrode and the Y electrode is adjusted.

In a subsequent address period, a compensation potential 109 and a potential 105 are applied to the X electrode, and a predetermined negative potential 111 is applied to the Y electrode. In this state, a scan pulse 113 is further sequentially applied to the Y electrode. In accordance with the application of the scan pulse 113, an address pulse 115 is applied to the address electrodes of the cells to be turned on. Consequently, discharges are generated between the Y electrode to which the scan pulse has been applied and the address electrode to which the address pulse has been applied, and these discharges trigger the generation of discharges between the X discharge electrode and the Y discharge electrode. Through this address discharge, negative wall charge is formed near the X discharge electrode (on the surface of the dielectric layer), and positive wall charge is formed near the Y discharge electrode. Since the address discharge is not generated in the cells to which the scan pulse or the address pulse is not applied, the wall charge at the time of the reset is maintained. In the address period, the scan pulses are sequentially applied to all of the Y electrodes to carry out the above-described operations, and address discharges are generated in all of the cells to be turned on in the entire panel surface.

When the address period is finished, the X electrode and the Y electrode are temporarily set to 0 V. Note that, at the end of the address period, pulses for adjusting the wall charges which have been formed in the reset period are applied in some cases in the cells in which the address discharges are not generated.

In the sustain discharge period, a negative sustain discharge pulse 117 of a potential −Vs is applied to the X electrode, and a positive sustain pulse 119 of a potential +Vs is applied to the Y electrode. In each of the cells in which the address discharge has been carried out, the voltage by the positive wall charge formed near the Y discharge electrode is superposed on the potential +Vs, and the voltage by the negative wall charge formed near the X discharge electrode is superposed on the potential −Vs. Consequently, the voltage between the X electrode and the Y electrode exceeds the firing voltage, and the sustain discharge is generated. When this discharge is finished, a positive wall charge is formed near the X discharge electrode, and a negative wall charge is formed near the Y discharge electrode.

Next, a positive sustain discharge pulse 121 of a potential +Vs is applied to the X electrode, and a negative sustain discharge pulse 123 of a potential −Vs is applied to the Y electrode. In the cell in which the first sustain discharge is performed, the voltage by the positive wall charge formed near the X discharge electrode is superposed on the potential +Vs, and the voltage by the negative wall charge formed near the Y discharge electrode is superposed on the potential −Vs. Consequently, the voltage between the X discharge electrode and the Y discharge electrode exceeds the firing voltage, and the second sustain discharge is generated between the X discharge electrode and the Y discharge electrode. When the second sustain discharge is finished, the negative wall charge is formed near the X discharge electrode, and the positive wall charge is formed near the Y discharge electrode.

Thereafter, by applying the sustain discharge pulses in which polarities are alternately changed to the X electrode and the Y electrode in the same manner, the sustain discharge is repeatedly carried out.

In the standard PDP device today, Vs mentioned above is about 90 V. Therefore, a driving element operated as a switch for controlling the connection between the electrodes and the positive and negative voltage sources with a large absolute value cannot be driven by an output signal of the voltage +5V of a normal logic circuit. Therefore, a drive circuit having a photocoupler is used to control the driving element in the conventional technology. However, the drive circuit having a photocoupler causes a problem of cost increase.

Japanese Patent Application Laid-Open Publication No. 2004-274719 (Patent Document 1) discloses a pre-drive circuit of a PDP device, in which a driver IC having a low-level shift circuit and a high-level shift circuit is used and a photocoupler is not used. FIG. 3 is a diagram showing an example of a structure of the driver IC described in the patent document 1. In this driver IC, as shown in FIG. 3, two low-level shift circuits 133 and 134 and two high-level shift circuits 137 and 138 are provided, and two pairs of pre-drive circuits can be formed. A terminal 111 is a terminal to which the power supply VI1 of an input circuit is to be inputted and is usually connected to a power supply Vcc (for example, voltage +5V) of a logic circuit. A terminal 114 is a ground (GND) terminal. A terminal 115 is a terminal to which a reference potential COM of the low-level shift circuit is to be inputted, and for example, the voltage −Vs is inputted thereto. A terminal 116 is a terminal to which an activation potential Vc of the low-level shift circuit is inputted, and it is connected to a power supply FVcc (voltage FVcc=−Vs+Vcc). Terminals 117 and 120 are terminals to which voltages OV1 and OV2 which define the high-side voltage level of the output signal are inputted. Terminals 119 and 122 are terminals to which voltages RV1 and RV2 which define the low-side voltage level of the output voltage are inputted.

Signals IN1 and IN2 inputted from the terminals 112 and 113 are received in the input circuits 131 and 132, and then inputted to the first and second low-level shift circuits 133 and 134, in which they are converted into signals based on the reference potential COM. The converted signals are inputted to the first and second high-level shift circuits 137 and 138 via buffer circuits 135 and 136, in which they are converted into signals of the level defined by the voltages OV1 and OV2 and the voltages RV1 and RV2. The signals are outputted as output signals OUT1 and OUT2 from terminals 118 and 121 via buffer circuits 139 and 140.

Since this driver IC is described in detail in the patent document 1, the more description thereof is omitted here.

When the driver IC of FIG. 3 is activated, a voltage −Vs is first applied as the reference potential COM, and then, other power supplies are applied in general. As described later, when the driving circuit is formed by using the driver IC of FIG. 3, the terminals 119 and 122 of the driver IC are connected to the terminals of the driving element driven by the driver IC. In this case, the reference potential COM must be lower than the voltage of the terminal of the driving element. If other power supply is applied before a voltage −Vs is applied as the reference potential COM, the signal having the voltage applied as the reference potential COM at that time, for example, the signal having a voltage close to the ground is outputted as the low-level output signal. At this time, if the negative power supply voltage is applied to the driving element driven by the driver IC, the output signal from the driver IC is high-level with respect to the negative power supply voltage supplied to the driving element although it is low-level, and it turns on the driving element in some cases. In such a case, the through current flows between the power supplies, and there is the possibility that the driving element and the power supply are broken.

On the other hand, Japanese Patent No. 3201603 (Patent Document 2) discloses a structure of the PDP device in which positive and negative sustain discharge voltages are applied to the X electrode and the Y electrode. In this structure, a power supply circuit for generating a positive sustain discharge voltage +Vs and a capacitor in which the positive sustain discharge voltage is charged are provided, and when a negative sustain discharge voltage −Vs is to be applied, a positive-side terminal of the capacitor in which +Vs is charged is switched to be connected to the ground, and −Vs is generated on a negative-side terminal thereof and then applied to the driving element. In this structure, the power supply circuit for generating the negative sustain discharge voltage −Vs becomes unnecessary, and the structure of the power supply circuit can be simplified.

However, even in the structure disclosed in the patent document 2, stable −Vs is required as a reference potential when using the driver IC shown in FIG. 3, and a power supply circuit for generating −Vs is necessary. In this case, the current capacity of −Vs supplied to the driver IC is much lower than the current capacity of the negative sustain discharge voltage −Vs supplied for the sustain discharge to the driving element, and the power supply circuit can be simplified by employing the structure of the patent document 2.

FIG. 4A is a diagram showing a structure of the conventional power supply of the PDP device in which the driver IC of FIG. 3 is used and the structure of the patent document 2 is applied, and FIG. 4B is a diagram showing the activation operation of the driver IC.

As shown in FIG. 4A, an AC power supply line 31 connected to a power line is connected to a Vcc power supply 33, a +Vs power supply 34, and a −Vs power supply 35 via a switch 32. Then, the sequence is set so that the Vcc power supply 33 rises first, the −Vs power supply 35 rises next, and then, the +Vs power supply 34 rises. A voltage Vw which is higher than +Vs to be applied to the Y electrode at the time of reset is generated by a Vw power supply 36 from +Vs generated by the +VS power supply 34. The activation voltage FVcc of the low-level shift circuit is generated by a FVcc power supply 37 from the voltage −Vs generated by the −Vs power supply 35 and the voltage Vcc generated by the Vcc power supply 33. The FVcc power supply 37 is a circuit for adding the voltage Vcc to the voltage −Vs, and it outputs the voltage Vcc when a ground level is outputted from the −Vs power supply 35 before the voltage −Vs is generated.

When each of the voltages generated in the above-mentioned manner is supplied to the driver IC, as shown in FIG. 4B, the voltage −Vs is first applied at the same time with the rise thereof, and Vcc and FVcc are next applied simultaneously. At this time, the logic signal is also applied. Then, the rise of the +Vs power supply is started at the same time when a charging switch which connects a capacitor for generating the negative sustain discharge voltage −Vs to the +Vs power supply and the ground is turned on. The reason why the rise of the +Vs power supply is started after turning on the charging switch as described above is that, if the charging switch is turned on in a state where the voltage +Vs is being outputted after the rise of the +Vs power supply, due to the large capacity of the above-described capacitor, large current flows through the charging switch and the charging switch is broken. FVcc is equal to −Vs+Vcc and is applied after −Vs is stabilized.

### SUMMARY OF THE INVENTION

As shown in FIG. 4A, in the conventional PDP device, both the +Vs power supply 34 for generating +Vs from an AC power supply and the −Vs power supply 35 for generating −Vs are provided in order to supply −Vs which is the reference potential to the IC driver first. Since the power supply circuit for generating direct voltage from AC power supply has a large circuit size, when power supply circuits for generating three voltages from the AC power supply, in particular, circuits for generating +Vs and −Vs having a large absolute value of voltages are provided, the size of the power supply circuit is increased, and the cost thereof is also increased.

An object of the present invention is to solve the problems described above and to reduce the cost of the power supply circuit of the PDP device.

In order to achieve the object described above, in the plasma display device according to the present invention, the reference potential −Vs to be applied to the driver IC is generated from the positive sustain discharge voltage +Vs, and the activation potential +Vs of the high-level shift circuit and the low-level shift circuit is applied prior to the reference potential at the time of the activation of the pre-driver IC.

More specifically, a plasma display device according to the present invention comprises: a plasma display panel having a plurality of electrodes; driving circuits for applying voltages to the plurality of electrodes; and a power supply circuit for supplying power supply voltage to the driving circuits, wherein the driving circuits apply a positive sustain discharge voltage which is higher than the ground and a negative sustain discharge voltage which is lower than the ground to the plurality of electrodes at the time of sustain discharge, the driving circuit has low-level shift circuits and high-level shift circuits and is provided with pre-driver ICs to which an activation potential of the high-level shift circuit, an activation potential of the low-level shift circuit, and a reference potential lower than the negative sustain discharge voltage have to be applied, the power supply circuit is provided with a positive sustain discharge voltage generating unit which generates the positive sustain discharge voltage from an AC power supply and a reference potential generating unit which generates the reference potential from the positive sustain discharge voltage generated by the positive sustain discharge voltage generating unit, and at the time when activating the pre-driver IC, an activation potential of the high-level shift circuit and the low-level shift circuit is applied prior to the reference potential.

The activation potential of the high-level shift circuit can correspond to the positive sustain discharge voltage +Vs, and the reference potential can correspond to the negative sustain discharge voltage −Vs.

In the case where the structure described in the patent document 2 is applied to the present invention, a capacitor for retaining the positive sustain discharge voltage, a charging switch for controlling the connection between the capacitor and a power supply terminal and a ground terminal of the positive sustain discharge voltage, a potential switch for controlling the connection between a positive-side terminal of the capacitor and the ground are provided, and after retaining the positive sustain discharge voltage in the capacitor, the terminal potential of the capacitor is switched by the potential switch to generate the negative sustain discharge voltage. In this case, the charging switch is controlled so that it is turned on when the rise of the positive sustain discharge voltage outputted from the positive sustain discharge voltage generating unit is started. Accordingly, it is possible to prevent the breakage of the charging switch due to the large rush current flowing into the charging switch.

Also, the potential switch is controlled so as not to be turned on until the reference potential is generated. Accordingly, the driving circuit does not output negative voltage until the reference potential is generated, and thus, it is possible to prevent the through current from flowing through the driving element.

Since the reference potential −Vs is generated from the positive sustain discharge voltage +Vs in the PDP device according to the present invention, the structure of the power supply circuit can be simplified and the cost thereof can be reduced.

According to the present invention, since the reference potential −Vs is generated from the positive sustain discharge voltage +Vs, the reference potential −Vs is generated and stabilized after the positive sustain discharge voltage +Vs is generated. Therefore, it is impossible to apply the reference potential −Vs first and apply the positive sustain discharge voltage +Vs next at the time when activating the driver IC, and it is impossible to stably operate all of the driving elements of the driving circuit controlled by the output signal of the driver IC.

However, the inventors of the present invention have found the following facts. That is, even when the reference potential −Vs cannot be first applied at the time when activating the driver IC, if the potential applied as the reference potential is the ground, the problem that the driving element which drives the electrode is turned on and the through current flows can be prevented as long as the voltage to be applied to the driving element which drives the electrode of the driving circuit is higher than the ground. In other words, if such conditions can be satisfied, the activation potential of the high-level shift circuit and the low-level shift circuit can be applied prior to the reference potential at the time when activating the driver IC.

According to the present invention, the power supply circuit of the PDP device can be simplified without any problems in the operation of the driving circuit.

### BRIEF DESCRIPTIONS OF THE DRAWINGS

FIG. 1 is a diagram showing an entire structure of a PDP device;

FIG. 2 is a diagram showing driving waveforms in the PDP device;

FIG. 3 is a diagram showing a structure of a driver IC used in the PDP device;

FIG. 4A is a diagram showing a structure of a power supply in a conventional example of a PDP device;

FIG. 4B is a diagram showing an activation operation of a driver IC in a conventional example of a PDP device;

FIG. 5 is a diagram showing the structure of pre-drive circuits and driving elements in a X electrode driving circuit and a Y electrode driving circuit in a PDP device according to a first embodiment of the present invention;

FIG. 6A is a diagram showing a structure of a power supply of the PDP device according to the first embodiment;

FIG. 6B is a diagram showing an activation operation of a driver IC in the PDP device according to the first embodiment;

FIG. 7 is a diagram showing a structure of a −Vs−Vw power supply; and

FIG. 8 is a diagram showing an example of a structure of pre-drive circuits and driving elements in a X electrode driving circuit and a Y electrode driving circuit in a PDP device according to a second embodiment of the present invention.

### DESCRIPTIONS OF THE PREFERRED EMBODIMENTS

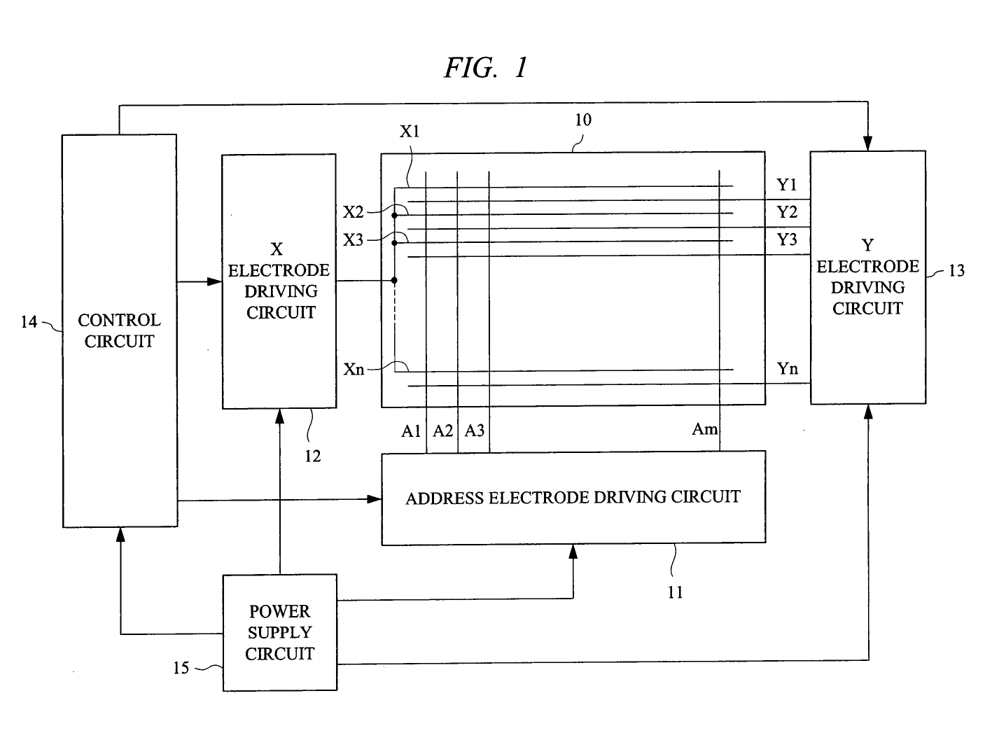

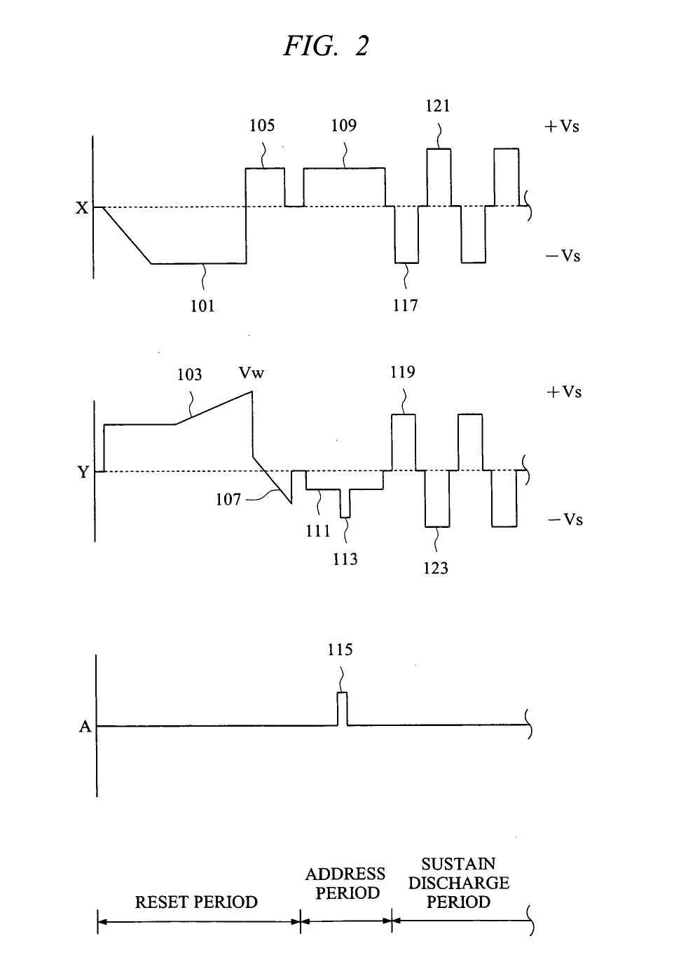

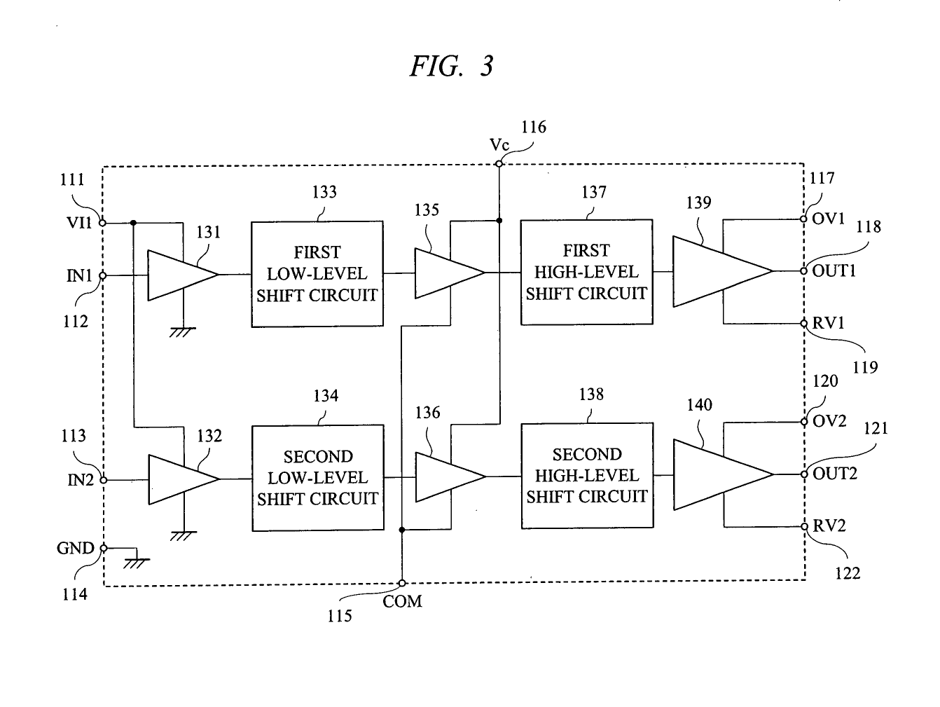

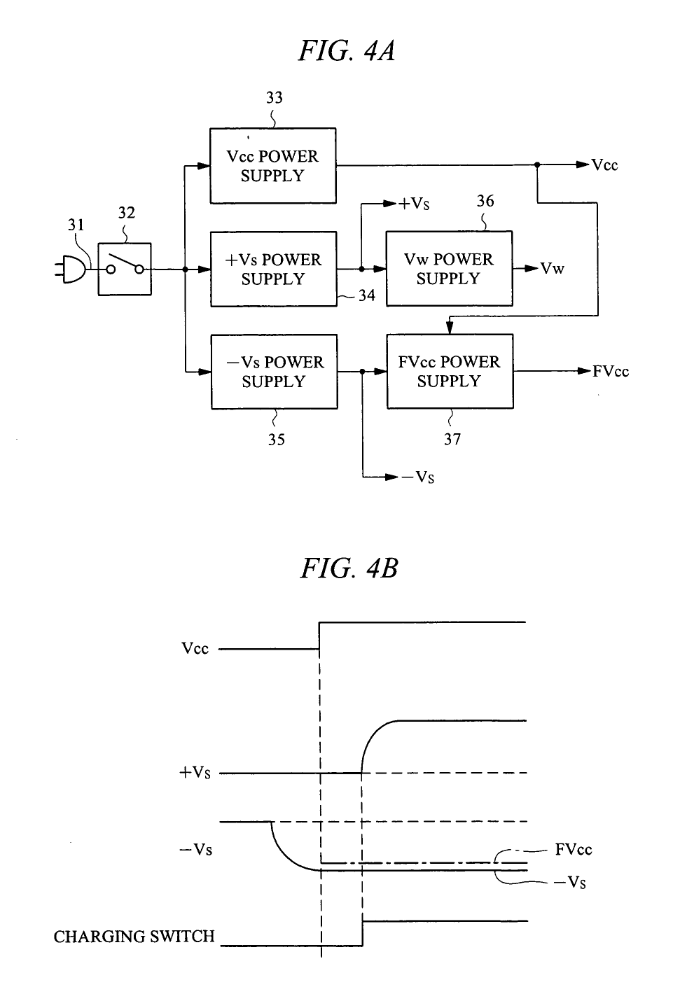

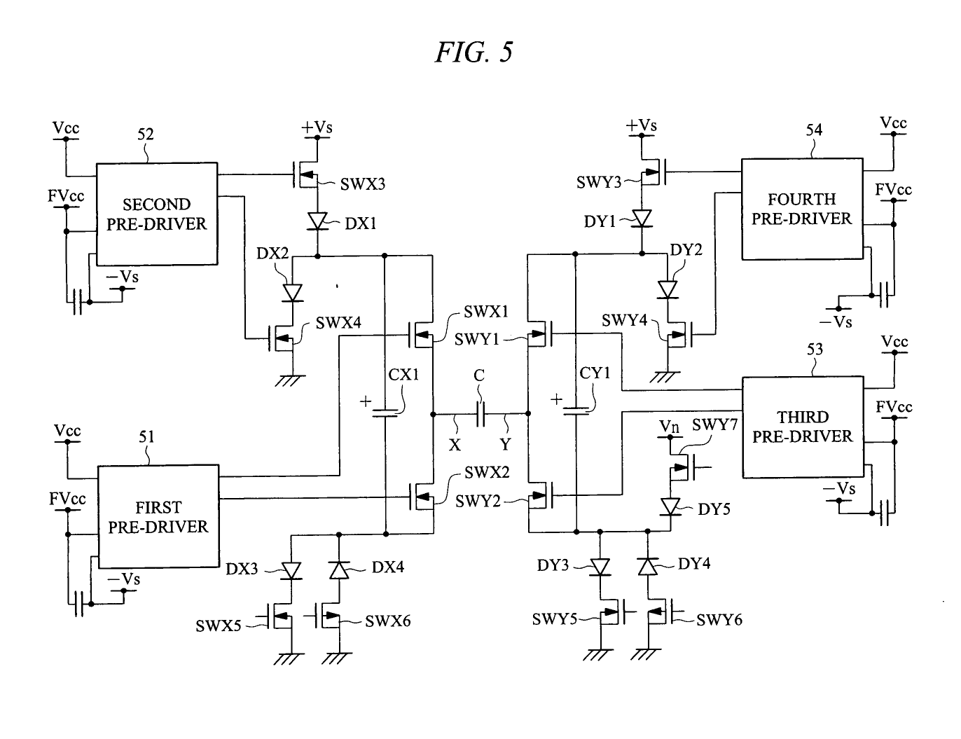

FIG. 5 is a diagram showing the structure of pre-drive circuits and driving elements in a X electrode driving circuit and a Y electrode driving circuit in a PDP device according to a first embodiment of the present invention. The PDP device according to the first embodiment has an entire structure as shown in FIG. 1, and driving waveforms shown in FIG. 2 are applied to each of the electrodes. Furthermore, the PDP device according to the first embodiment has the structure as described in patent document 2, and further, the driver IC shown in FIG. 3 is used to form the driving circuit. Note that, although the Y electrode driving circuit is provided with a shift register which generates a scan pulse in the address period, a driving element for applying a scan pulse to each Y electrode, and a diode in addition to the circuit components shown in FIG. 5, the description thereof is omitted here. Also, although power recovery circuits and others are provided in the X electrode driving circuit and the Y electrode driving circuit in order to reduce the power consumption, the description thereof is also omitted here.

As shown in FIG. 5, since the X electrode and the Y electrode are adjacently disposed, a capacitor C is formed, and the X electrode driving circuit and the Y electrode driving circuit drive this capacitor C.

The X electrode driving circuit includes a first switch SWX1 and a second switch SWX2 each having one terminal connected to the X electrode, a third switch SWX3 and a diode DX1 connected in series between the other terminal of the first switch SWX1 and the +Vs power supply, a fourth switch SWX4 and a diode DX2 connected in series between the other terminal of the first switch SWX1 and the ground, a fifth switch SWX5 and a diode DX3 connected in series between the other terminal of the second switch SWX2 and the ground, and a sixth switch SWX6 and a diode DX4 connected in series between the other terminal of the second switch SXW2 and the ground. Each of the switches is composed of a power MOSFET, IGBY or the like corresponding to a driving element. The first switch SWX1 and the second switch SWX2 are driven by a first pre-driver 51, and the third switch SWX3 and the fourth switch SWX4 are driven by a second pre-driver 52. The first and second pre-drivers 51 and 52 have the structure as shown in FIG. 3. A capacitor CX1 is connected between the other terminal of the first switch SWX1 and the other terminal of the second switch SWX2.

The Y electrode driving circuit has the structure similar to that of the X electrode driving circuit, in which SWY1 to SWY6 correspond to SWX1 to SWX6, DY1 to DY4 correspond to DX1 to DX4, third and fourth pre-drivers 53 and 54 correspond to the first and second pre-drivers 51 and 52, and CY1 corresponds to CX1, respectively. In addition to the components described above, the Y electrode driving circuit is provided with a seventh switch SWY7 and a diode DY5 connected in series between the other terminal of SWY2 and a Vw power supply which outputs the voltage Vw higher than +Vs applied at the time of reset.

As shown in FIG. 5, Vcc power supply, FVcc power supply and −Vs power supply are connected to the first to fourth pre-drivers 51 to 54. Also, though not shown, a terminal 122 of the first pre-driver 51 is connected to a connection node between the switch SWX2 and the diodes DX3 and DX4, and a terminal 120 is connected to a constant-voltage source (Ve power supply) (for example, Ve is +15 V) having one terminal connected to this connection node. Also, a terminal 119 of the first pre-driver 51 is connected to a connection node between SWX1 and SWX2, and a terminal 117 is connected to a constant-voltage source (Ve power supply) having one terminal connected to this connection node. Furthermore, a terminal 122 of the second pre-driver 52 is connected to the ground, and a terminal 120 is connected to a constant-voltage source (Ve power supply) having one terminal connected to the ground, a terminal 119 is connected to a connection node between SWX3 and the diode DX1, and a terminal 117 is connected to the constant-voltage source (Ve power supply) having one terminal connected to this connection node. Since the Y driving circuit has the similar structure, the description thereof is omitted here.

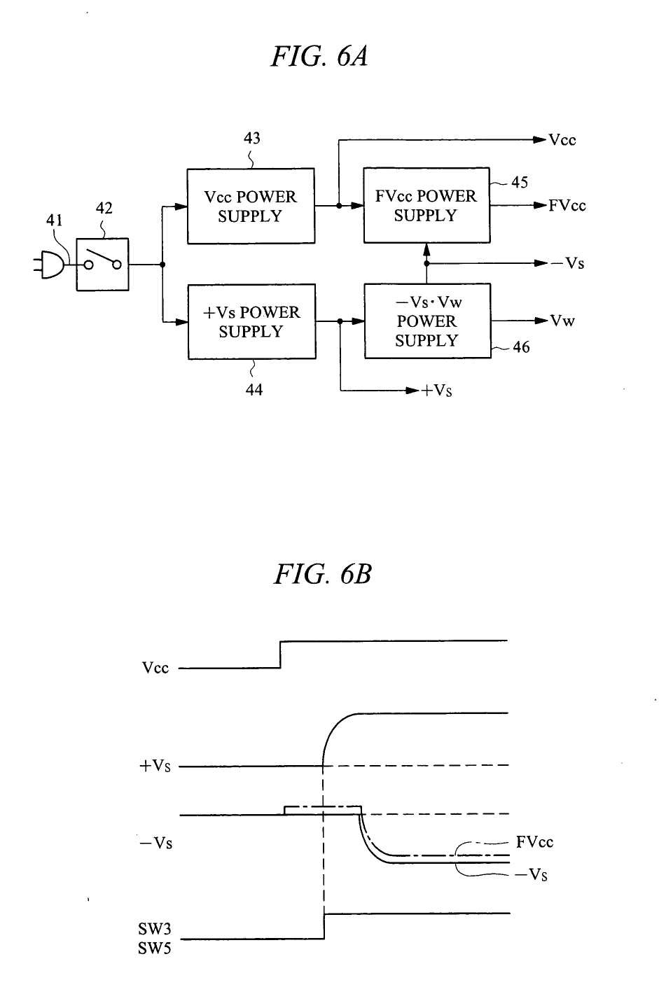

FIG. 6A is a diagram showing the structure of the power supply circuit of the PDP device according to the first embodiment, and FIG. 6B is a diagram showing the activation operation of the driver IC in the PDP device according to the first embodiment.

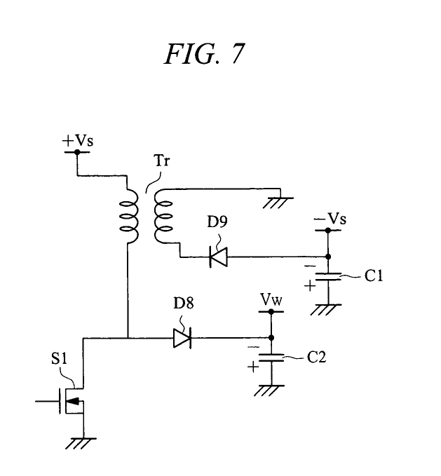

As shown in FIG. 6A, an AC power supply line 41 connected to a power line is connected to a Vcc power supply 43 and a +Vs power supply 44 via a switch 42. The voltage +Vs generated in the +Vs power supply 44 is supplied to a −Vs·Vw power supply 46, and the −Vs·Vw power supply 46 generates the voltage −Vs and the voltage Vw. FIG. 7 is a diagram showing the structure of the −Vs·Vw power supply 46. The voltage Vcc generated in the Vcc power supply 43 and the voltage −Vs generated in the −Vs·Vw power supply 46 are supplied to a FVcc power supply 45, and the FVcc power supply 45 generates the FVcc voltage. As shown in FIG. 6B, FVcc is equal to −Vs+Vcc. That is, after FVcc first becomes Vcc, it changes in accordance with the change of −Vs and becomes −Vs+Vcc at the time when −Vs is stabilized.

As shown in FIG. 7, in the −Vs·Vw power supply 46, +Vs is supplied to one terminal of a primary coil of a transformer Tr, and the other terminal of the primary coil of the transformer Tr is connected to the ground via a switch S1. By turning on/off the switch S1, the back electromotive force is generated by the primary coil of the transformer Tr, and the voltage of the other terminal of the primary coil of the transformer Tr becomes higher than the voltage +Vs in some cases. In this case, current flows from the other terminal of the primary coil of the transformer Tr to a capacitor C2 via a diode D8, and the voltage Vw higher than +Vs is stored in the capacitor C2. At the reset time, this voltage Vw is supplied to the Y electrode via the switch SWY7 of FIG. 5.

Furthermore, one terminal of a secondary coil of the transformer Tr is connected the ground, and −Vs is generated in the other terminal thereof −Vs is stored in the capacitor C1 via a diode D9. The voltage −Vs stored in the capacitor C1 is supplied to the first to fourth pre-drivers 51 to 54.

Anyway, in the present embodiment, since the voltage −Vs supplied to the first to fourth pre-drivers 51 to 54 is generated from the voltage +Vs, the voltage −Vs is generated after the voltage +Vs rises. The use of such a power supply circuit makes it possible to reduce the cost in comparison with the case where a circuit for independently generating the voltage −Vs is provided.

Returning to FIG. 6B, in the present embodiment, Vcc and FVcc are first applied to the first to fourth pre-drivers 51 to 54. Since −Vs is the ground GND level, FVcc at this time is equal to Vcc. Thereafter, the third and fifth switches SWX3 and SWX5 of the X driving circuit and the third and fifth switches SWY3 and SWYS of the Y driving circuit (illustrated as SW3 and SWS in combination) are turned on, and at the same time, the voltage +Vs starts to rise. Then, after the rise of the voltage +Vs is completed, the voltage −Vs starts to change. As described above, after FVcc first becomes Vcc, it changes in accordance with the change of −Vs and becomes −Vs+Vcc at the time when −Vs is stabilized.

Next, an operation at the time when activating the pre-drivers will be described. Since the Y electrode driving circuit operates in the same manner as that of the X electrode driving circuit, only the X electrode driving circuit will be described here.

First, Vcc is applied to the pre-driver, and Vcc is further applied thereto as FVcc. At this time, logic signals which turn off the switches SWX1 to SWX4 are inputted to the first and second pre-drivers 51 and 52. Therefore, output signals close to the ground are outputted from the first and second pre-drivers 51 and 52 and are applied to the gates of the switches SWX1 to SWX4. Accordingly, the switches SWX1 to SWX4 are brought into a turn off state. Similarly, output signals close to the ground are applied also to the gates of the switches SWX5 and SWX6, and the switches SWX5 and SWX6 are brought into a turn off state.

Next, logic signals which turn on the switch SWX3 is applied to the second pre-driver 52, and signals close to the voltage Ve (+15 V) are outputted from the second pre-driver 52 to turn on the switch SWX3. Further, the signals close to the voltage Ve are applied to the switch SWX5, and the switch SWX5 is brought into a turn on state. Accordingly, the terminal of the switch SWX2 is connected to the ground. At this time, it is desired that the switch SWX2 is brought into a turn on state by inputting a signal which turns on the switch SWX2 to the second pre-driver 52. This is in order to hold the X electrode to the ground level instead of a loading state.

Immediately thereafter, the +Vs power supply rises, and the output voltage of the +Vs power supply gradually increases toward +Vs. Accordingly, the capacitor CX1 is gradually charged via the switch SWX3 and the diode DX1 and via the switch SWX5 and the diode DX3, and at the time when the output voltage of the +Vs power supply reaches +Vs, the capacitor CX1 is charged to +Vs. In this manner, it is possible to prevent the large rush current from flowing when charging the capacitor CX1. Note that, at this time, since RV1 applied to the terminal 119 of the second pre-driver 52 also gradually increases, the voltage applied to the gate of the switch SWX3 gradually increases. Therefore, the switch SWX3 is held to a turn on state. The switch SWX2 is also held to a turn on state. In addition, the output signals applied to the gates of the switch SWX1 and SWX4 are still equal to the ground, and the switches SWX1 and SWX4 are held to a turn off state. Accordingly, the through current does not flow and the negative voltage due to the change of the terminal voltage of the capacitor CX1 is not generated.

After the output voltage of the +Vs power supply reaches +Vs, the output voltage of the −Vs power supply gradually decreases from the ground to the voltage −Vs. At the same time, FVcc also decreases. When the output voltage of the −Vs power supply reaches −Vs, −Vs is applied to the terminal 115 of the first pre-driver 51 as the reference potential COM. Therefore, the voltage of the terminal of the switch SWX2 can be changed to the voltage −Vs. Thereafter, the switches SWX2 and SWX3 are brought into a turn off state by changing the logic signals inputted to the first and second pre-drivers 51 and 52, thereby achieving the state where the operation can be stated. Note that it is also possible to bring the switches SWX2, SWX3, and SWX5 into a turn off state when the output voltage of the +Vs power supply reaches +Vs, that is, when the charging of the capacitor CX1 is completed.

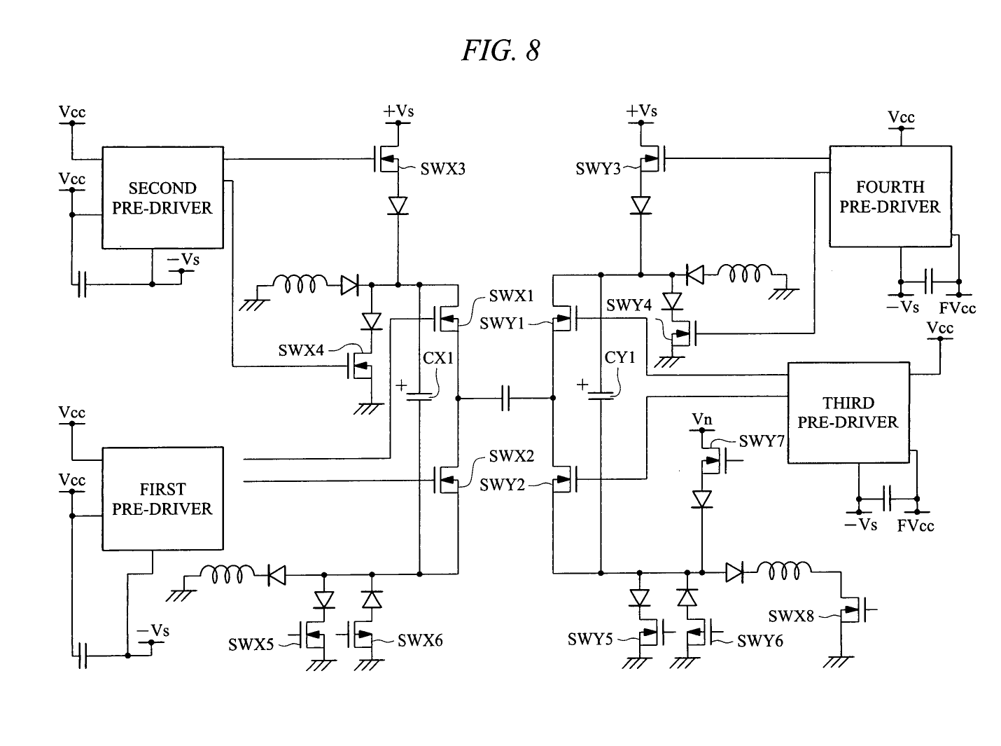

FIG. 8 is a diagram showing the structure of pre-drive circuits and driving elements in a X electrode driving circuit and a Y electrode driving circuit in a PDP device according to a second embodiment of the present invention. In the PDP device according to the second embodiment, the present invention is applied to the structure described in the International Publication WO2004/032108 (patent document 3), and as shown in FIG. 8, the difference from the circuit structure of the first embodiment shown in FIG. 5 lies in that circuits composed of a coil and a diode are connected to the terminals of the switches SWX1, SWX2, SWY1 and SWY2. Since the operation and the effects obtained by applying the present invention in the second embodiment are similar to those of the first embodiment, the further description thereof is omitted here.

As described above, according to the present invention, it is possible to reduce the cost without any problems in the operation of the PDP device, and a PDP device with good display quality can be realized at low cost.

What is claimed is:

1. A plasma display device comprising:
a plasma display panel having a plurality of electrodes;
driving circuits for applying voltages to said plurality of electrodes; and
a power supply circuit for supplying power supply voltage to said driving circuits,
wherein said driving circuits apply a positive sustain discharge voltage which is higher than the ground and a negative sustain discharge voltage which is lower than the ground to said plurality of electrodes at the time of sustain discharge,
said driving circuit has low-level shift circuits and high-level shift circuits and is provided with pre-driver ICs to which an activation potential of said high-level shift circuit, an activation potential of said low-level shift circuit, and a reference potential lower than said negative sustain discharge voltage have to be applied,
said power supply circuit is provided with a positive sustain discharge voltage generating unit which generates said positive sustain discharge voltage from an AC power supply and a reference potential generating unit which generates said reference potential from said positive sustain discharge voltage generated by said positive sustain discharge voltage generating unit, and
at the time when activating said pre-driver IC, an activation potential of said high-level shift circuit and said low-level shift circuit is applied prior to said reference potential.

2. The plasma display device according to claim 1,
wherein the activation potential of said high-level shift circuit corresponds to said positive sustain discharge voltage, and said reference potential corresponds to said negative sustain discharge voltage.

3. The plasma display device according to claim 2,
wherein said driving circuit is provided with a capacitor which retains said positive sustain discharge voltage, a charging switch which controls connection between said capacitor and a power supply terminal of said positive sustain discharge voltage and between said capacitor and a ground terminal, and a potential switch which controls connection between a positive-side terminal of said capacitor and the ground, and after retaining said positive sustain discharge voltage in said capacitor, a terminal potential of said capacitor is switched by said potential switch, thereby generating said negative sustain discharge voltage.

4. The plasma display device according to claim 3,
wherein said charging switch is controlled so that it is turned on when said positive sustain discharge voltage outputted from said positive sustain discharge voltage generating unit starts to rise.

5. The plasma display device according to claim 4,
wherein said potential switch is controlled so that it is not turned on until said reference potential is generated, and said driving circuit does not output a negative voltage until said reference potential is generated.

6. The plasma display device according to claim 3,
wherein said potential switch is controlled so that it is not turned on until said reference potential is generated, and said driving circuit does not output a negative voltage until said reference potential is generated.

7. The plasma display device according to claim 1,
wherein said driving circuit is provided with a capacitor which retains said positive sustain discharge voltage, a charging switch which controls connection between said capacitor and a power supply terminal of said positive sustain discharge voltage and between said capacitor and a ground terminal thereof, and a potential switch which controls connection between a positive-side terminal of said capacitor and the ground, and after retaining said positive sustain discharge voltage in said capacitor, a terminal potential of said capacitor is switched by said potential switch, thereby generating said negative sustain discharge voltage.

8. The plasma display device according to claim 7,
wherein said charging switch is controlled so that it is turned on when said positive sustain discharge voltage outputted from said positive sustain discharge voltage generating unit starts to rise.

9. The plasma display device according to claim 8,
wherein said potential switch is controlled so that it is not turned on until said reference potential is generated, and said driving circuit does not output a negative voltage until said reference potential is generated.

10. The plasma display device according to claim 7,
wherein said potential switch is controlled so that it is not turned on until said reference potential is generated, and said driving circuit does not output a negative voltage until said reference potential is generated.
